(19) United States
(12) Patent Application Publication
(10) Pub. No.: US 2025/0153573 A1
(43) Pub. Date: May 15, 2025

(54) VARIABLE CAPACITY STACK-TYPE BRAKE RESISTOR

(71) Applicant: JAHWA ELECTRONICS CO., LTD., Cheongju-si, Chungcheongbuk-do (KR)

(72) Inventors: Seong Tae PARK, Jeungpyeong-gun, Chungcheongbuk-do (KR); Jong Up KIM, Cheongju-si, Chungcheongbuk-do (KR); In Chae PARK, Osan-si, Gyeonggi-do (KR); Chang Yong SHEEN, Chilgok-gun, Gyeongsangbuk-do (KR); Deok Koo JI, Cheongju-si, Chungcheongbuk-do (KR)

(73) Assignee: JAHWA ELECTRONICS CO., LTD., Cheongju-si, Chungcheongbuk-do (KR)

(21) Appl. No.: 18/833,988

(22) PCT Filed: Nov. 10, 2023
(86) PCT No.: PCT/KR2023/018082

§ 371 Date: Jul. 29, 2024

(30) Foreign Application Priority Data
Nov. 23, 2022 (KR) 10-2022-0158710

(51) Int. Cl. B60L 7/22; H01C 1/082; H01C 10/16; H01C 13/02; H02P 3/22

(52) U.S. Cl. CPC B60L 7/22; H01C 1/082; H01C 10/16; H01C 13/02; H02P 3/22

(57) ABSTRACT

A variable capacity stack-type brake resistor including at least one resistance module having one or more heating elements therein, one control module including a substrate electrically connected to the heating elements, an inlet port connected to a fluid inlet on one side of the resistance module, and an outlet port connected to a fluid outlet on the other side of the resistance module, wherein the resistance module is provided in a box shape with flat upper and lower surfaces, and the control module is assembled in a stacked manner on the upper surface of the resistance module. According to the brake resistor, total capacity (capacity to consume energy) may be changed as desired by adjusting the number of resistance modules assembled in a stacked manner as needed, thereby satisfying the required specifications and responding quickly to requests for specification changes without major replacement or changes to production equipment.

### TECHNICAL FIELD

The present disclosure relates to a brake resistor and, more particularly, to a brake resistor that converts excess energy (electrical energy) produced by an electric motor, during regenerative braking of eco-friendly vehicles such as pure electric vehicles or hydrogen fuel cell vehicles, into heat and quickly dissipates this thermal energy.

### BACKGROUND

Eco-friendly vehicles such as hybrid vehicles, pure electric vehicles, and hydrogen fuel cell vehicles are equipped with electric motors as an auxiliary or main power source. In addition to generating power to drive a vehicle, electric motors perform regenerative braking to assist braking during deceleration or coasting, while acting as a generator by converting the vehicle's kinetic energy into electrical energy to charge a battery.

Generally, in eco-friendly vehicles, electrical energy stored in a battery is used as an energy source to generate driving power by supplying the electrical energy to an electric motor through a converter, and an electrical energy generated by the electric motor during regenerative braking in deceleration or coasting situations is charged to the battery through an inverter. At this time, auxiliary braking force is generated when the electric motor functions as a generator.

The auxiliary braking force in a regenerative braking situation is similar to the maximum torque when the electric motor is in discharge operation. Although regenerative braking is groundbreaking enough to play a similar role to mechanical brakes, it cannot completely replace mechanical brakes. This is because there are situations in which regenerative braking cannot continue, such as when electrical energy generated by an electric motor may no longer be accommodated, for example, when a battery is fully charged.

In situations where electrical energy produced by an electric motor can no longer be accommodated, such as when a battery is fully charged, the electrical energy must be forcibly consumed to enable regenerative braking. One of the technologies that ensures the sustainability of regenerative braking by forcibly consuming the surplus energy produced by an electric motor when a battery is fully charged is to use a brake resistor.

The brake resistor is designed to force energy consumption by generating heat (electrical energy→thermal energy) using the surplus electrical energy produced by an electric motor in situations where a battery can no longer accommodate the electrical energy produced by the electric motor, such as when the battery is fully charged, and has the advantage of being able to dissipate surplus electrical energy produced by an electric motor stably and quickly.

However, since most conventional brake resistors applied to eco-friendly vehicles have a controller part and a register body part composed separately, it is inevitable that, when installing a brake resistor in an actual vehicle, there are difficulties in securing space. In addition, as the controller part and the register body part are constructed separately, there is also a disadvantage that a separate dedicated cable is needed to electrically connect the controller part and the register body part.

Moreover, because most conventional brake resistors have their capacity determined according to required specifications, and the product is designed and manufactured according to determined capacity, there was no choice but to respond to market demands by configuring the product lineup in a variety of ways (organizing products by capacity, etc.). If there was a request for a product specification that was not in the lineup, everything from product design to production had to start from scratch.

### Document of Related Art

### SUMMARY

The present disclosure is intended to solve the above problems occurring in the related art. An objective of the present disclosure is to provide a variable capacity stack-type brake resistor that increases space utilization, satisfies the specifications desired by consumers, and responds quickly to requests for specification changes.

In order to achieve the above mentioned objectives, there is provided a variable capacity stack-type brake resistor including:
at least one resistance module having one or more heating elements therein;
one control module including a substrate electrically connected to the heating elements;
an inlet port connected to a fluid inlet on a first side of the resistance module; and
an outlet port connected to a fluid outlet on a second side of the resistance module,
wherein the resistance module may be provided in a box shape with flat upper and lower surfaces, and
the control module may be assembled in a stacked manner on the upper surface of the resistance module.

In an embodiment of the present disclosure, two or more resistance modules may be provided and the two or more resistance modules may be assembled in a stacked manner, and the control module may be assembled in the stacked manner on the upper surface of the resistance module located at a top among the resistance modules assembled in the stacked manner.

When the resistance modules and the control module are stacked, the resistance modules and the control module may be stacked and combined into one unit by means of a connection unit.

At this time, the connection unit may preferably include: a base plate mounted in contact with the lower surface of the resistance module located at a bottom among the resistance modules; and at least one connection bracket that extends vertically from the base plate and secures the resistance modules and the control module.

Each of the one or more heating elements of each of the resistance modules applied to an embodiment of the present disclosure may have a power electrode and a ground electrode at a first end and a second end, respectively, thereof, wherein the power electrodes of the heating elements may be simultaneously connected to a positive (+) terminal of the control module by means of a first bus bar, and the ground electrodes of the heating elements may be simultaneously connected to a negative (−) terminal of the control module by means of a second bus bar, so that temperatures of the heating elements may be controlled simultaneously.

As another example, each of the one or more heating elements of each of the resistance modules may have a power electrode and a ground electrode at a first end and a second end, respectively, thereof, wherein the power electrodes of the heating elements may be individually connected to a corresponding number of positive (+) terminals provided in the control module by means of unit bus bars, and the ground electrodes of the heating elements may be simultaneously connected to a negative (−) terminal of the control module by means of one bus bar, so that temperatures of the heating elements may be controlled individually.

In addition, an inlet port on a first side of any one of the resistance modules may be connected to an inlet port on a first side of another resistance module adjacent to the any one of the resistance modules, and an outlet port on a second side of any one of the resistance modules may be connected to an outlet port on a second side of another resistance module adjacent to the any one of the resistance modules.

Alternatively, the inlet port may be configured as a single object in which two or more branch inlet pipes are branched from one main inlet pipe, and the outlet port may be configured as a single object in which two or more branch outlet pipes are branched from one main outlet pipe.

In addition, in an embodiment of the present disclosure, an elastic pad may be interposed between any one of the resistance modules and another resistance module adjacent to the any one of the resistance modules, and between the resistance module and the control module. At this time, the elastic pad may be a silicone pad.

In addition, in an embodiment of the present disclosure, a water temperature sensor may be attached to the outlet port to detect temperature of a fluid that has been heated up while passing through the resistance module. In this case, by feedback controlling the heating elements on the basis of the temperature information of a fluid detected by the water temperature sensor, the consumption of surplus energy may be adjusted.

In addition, the resistance module applied to an embodiment of the present disclosure may include: a coolant box with a side open and the fluid inlet and the fluid outlet formed; a sealing plate sealingly coupled to the open side of the coolant box, and a heating element assembly consisting of the heating elements, which is placed inside the coolant box and opposite ends of which are fixed to the sealing plate; and a terminal housing coupled to a front of the sealing plate, and that mounts a positive integrated terminal and a negative integrated terminal respectively connected to a power electrode at a first end of each of the heating elements and a ground electrode at a second end of each of the heating elements.

Preferably, each of the resistance modules may consist of two or more heating elements, each heating element may have a corrugated shape with two or more bending points or inflection points in a planar shape thereof, the heating elements may be spaced apart from each other at a predetermined distance in a height direction of the coolant box, and two heating elements adjacent to each other above and below may have different horizontal alignment positions.

When each of the resistance modules consists of two or more heating elements, the power electrodes at one ends of the heating elements included in one resistance module may be electrically integrated through one positive integrated terminal, and the ground electrodes at the other ends of the heating elements included in one resistance module may be electrically integrated through one negative integrated terminal.

In addition, an internal space of the terminal housing may be divided, by a central separation partition wall, into a first space and a second space in which the positive integrated terminal and the negative integrated terminal are respectively mounted, and upper and lower plates of the terminal housing may be provided with bus bar through holes through which bus bars pass, wherein the bus bars may electrically connect the positive integrated terminal and the negative integrated terminal for the first space and the second space, respectively, to the control module.

In addition, a diaphragm may be installed on the sealing plate and inside the coolant box to divide a fluid flow path in the coolant box in a zigzag shape when the sealing plate is combined with the coolant box.

In addition, the control module may be provided with a casing with an open top and a cover coupled to cover an upper open end of the casing, wherein the substrate may be placed inside the casing, and a heat sink for cooling highly heat generating control elements mounted on the substrate may be disposed inside the casing so that at least a portion of the heat sink may be in contact with the substrate.

A brake resistor according to an embodiment of the present disclosure is a stacked assembly type, and thus the number of resistance modules to be stacked can be easily adjusted as needed. That is, the entire capacity of the brake resistor can be easily varied to meet the required specifications, and requests for specification changes can be quickly responded to without major equipment changes or replacement.

Furthermore, according to the present disclosure, as the brake resistor is structured in a box shape as a whole, the brake resistor does not take up an unnecessary amount of space, making it advantageous for installation in an actual vehicle and improving space utilization. In addition, the on/off or temperature of the resistance modules can be controlled simultaneously or individually, allowing efficient energy consumption management according to the remaining energy. In the event of a failure, only a failed part (module) needs to be replaced, which can reduce maintenance costs.

### BRIEF DESCRIPTION OF DRAWINGS

FIG. 1 is a partially separated perspective view of a variable capacity stack-type brake resistor according to an embodiment of the present disclosure;

FIG. 2 is a combined perspective view of the brake resistor shown in FIG. 1;

FIGS. 3 to 5 are front, side, and top views of the brake resistor shown in FIG. 2;

FIG. 6 is an exploded perspective view of a resistance module constituting the variable capacity stack-type brake resistor according to an embodiment of the present disclosure;

FIG. 7 is a front view of a combined state of the resistance module in FIG. 6 with a housing cover and an integrated terminal omitted;

FIG. 8 is a front view of a combined state of the resistance module in FIG. 6 with only the housing cover omitted;

FIG. 9 is an exploded perspective view of a control module constituting the variable capacity stack-type brake resistor according to an embodiment of the present disclosure;

FIG. 10 is a partially exploded perspective view of the control module shown in FIG. 9;

FIG. 11 is a view showing an electrical connection relationship between the resistance modules and the control module, and is a combined perspective view of the present disclosure with the housing cover omitted;

FIG. 12 is a front view of a variable capacity stack-type brake resistor according to another embodiment of the present disclosure showing another electrical connection relationship between resistance modules and a control module;

FIG. 13 is a view showing a preferred embodiment of an inlet port and an outlet port;

FIG. 14 is a view showing another preferred embodiment of an inlet port and an outlet port; and

FIG. 15 is a view showing various modifications of the positions of an inlet of the inlet port (the part where a fluid flows in) and an outlet of the outlet port (the part where a fluid with an increased temperature is discharged).

### DETAILED DESCRIPTION

Hereinafter, preferred embodiments of the present disclosure will be described in detail.

The terms used in the specification are only used to describe specific embodiments and are not intended to limit the present disclosure. Singular forms are intended to include plural forms unless the context clearly indicates otherwise.

It should be understood that the terms “comprise (include)” or “have” used in this specification, specify the presence of stated features, steps, operations, components, parts, or a combination thereof, but do not preclude the presence or addition of one or more other features, numerals, steps, operations, components, parts, or a combination thereof.

In addition, terms including ordinal numbers such as “first”, “second”, etc. may be used to describe various components, but the components are not to be construed as being limited to the terms. The terms are used only to distinguish one component from another component.

Furthermore, terms such as “ . . . part”, “ . . . unit”, and “ . . . module” used in the specification refer to a unit that processes at least one function or operation, which may be implemented as hardware, software, or a combination of hardware and software.

When explaining with reference to the attached drawings, identical drawing reference numerals will be assigned to identical components, and overlapping descriptions thereof will be omitted. In addition, in explaining the present disclosure, if it is determined that a detailed description of related known technology may unnecessarily obscure the gist of the present disclosure, the detailed description will be omitted.

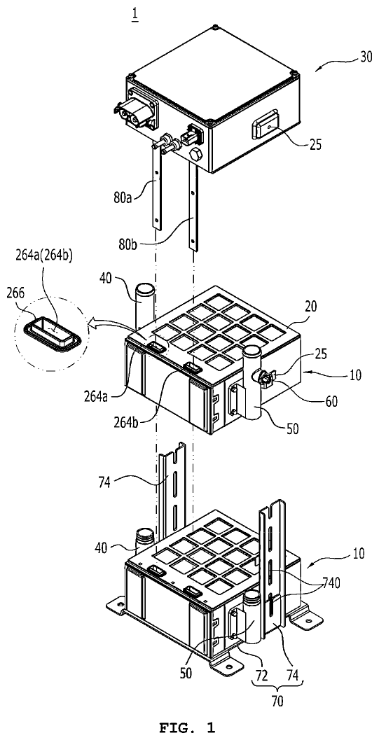

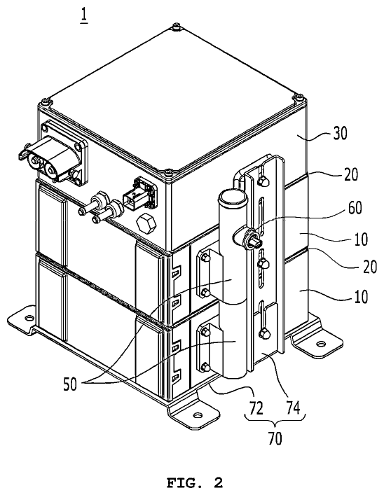

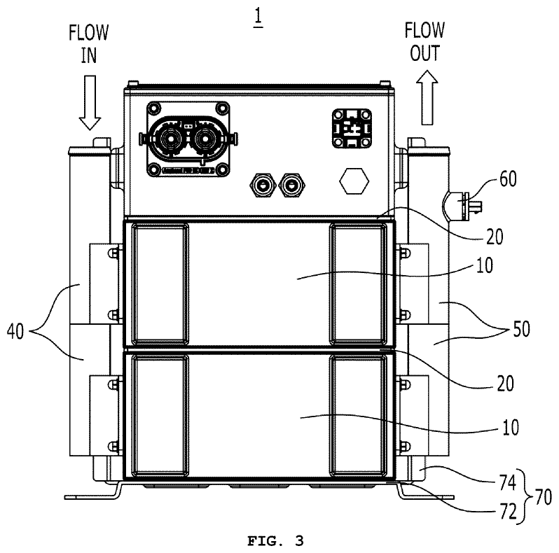

FIG. 1 is a partially separated perspective view of a variable capacity stack-type brake resistor according to an embodiment of the present disclosure, FIG. 2 is a combined perspective view of the brake resistor shown in FIG. 1, and FIGS. 3 to 5 are front, side, and top views of the brake resistor shown in FIG. 2.

Referring to FIGS. 1 to 5, a brake resistor 1 according to an embodiment of the present disclosure is designed to convert excess electrical energy into heat energy and force the heat energy to be consumed so that regenerative braking may be continuously performed even when decelerating or coasting with a battery fully charged. The brake resistor 1 may be composed of one or more resistance modules 10 and one control module 30.

Although the drawing shows a configuration with two resistance modules 10 as a preferred embodiment, depending on the requirements, only one resistance module 10 may be installed, or three or more resistance modules 10 may be configured, and thus it is not limited to two. It should be noted that the configuration with two resistance modules 10 is a preferred embodiment for explaining the present disclosure.

The resistance module 10 may include one or more heating elements 142. The heating element 142 may be an electrical resistive heating element 142 that converts electrical energy into heat energy due to internal resistance when current flows. For example, the heating element 142 may be a sheath heater that has a electrothermal wire built into a metal protective tube and is filled with insulation powder, such as magnesium oxide, to insulate the electrothermal wire and the metal protective tube.

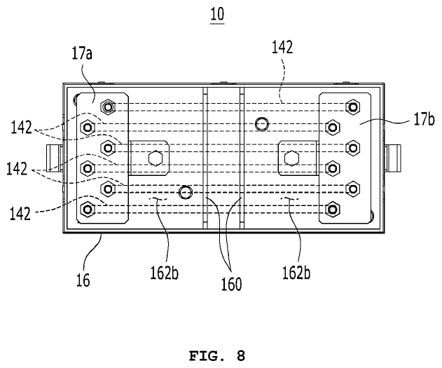

The resistance module 10 may have a square box shape (cuboid shape) with flat upper and lower surfaces, and the control module 30 may have a substrate 35 electrically connected to the heating element 142 mounted therein (see FIG. 9). Two or more resistance modules 10 may be assembled in a stacked manner, and the control module 30 may be assembled in a stacked manner on the upper surface of the uppermost resistance module 10 among the plurality of resistance modules 10.

An inlet port 40 may be connected to a fluid inlet 120 on one side of the resistance module 10, and an outlet port 50 may be connected to a fluid outlet 122 on the other side of the resistance module 10. A fluid flows into a coolant box 12 of the resistance module 10 through the inlet port 40, and the fluid passing through the inside of the coolant box 12 may be discharged to the outside through the outlet port 50. In this process, the fluid cools the heating element 142 inside the coolant box 12 and consumes energy.

For reference, the fluid that cools the heating element 142 while passing through the coolant box 12 so that the heating element 142 consumes energy may be pure water or water mixed with antifreeze. The fluid may be a liquid other than water that is commonly used as a coolant.

When one or two or more resistance modules 10 and the control module 30 are stacked and assembled, the resistance modules 10 and the control module 30 may be stacked and assembled into one unit by a connection unit 70. The connection unit 70 may include: a base plate 72 mounted so that the lower surface of the lowest resistance module 10 among the plurality of resistance modules 10 is in contact; and one or more connection brackets 74 extend vertically from the base plate 72 and secure the resistance modules 10 and the control module 30.

At the edge of the base plate 72, at least one pair of mounting flanges (numerals omitted) with bolt holes may be provided integrally so as to fix the brake register 1 with bolts at a designated location on a vehicle when the brake register 1 according to an embodiment of the present disclosure is installed on the actual vehicle. In the connection bracket 74, long holes 740 may be formed at regular intervals along the length direction (height direction in the drawing) thereof.

One fastened member 25 may be attached to the side portion of each of the resistance modules 10 and the control module 30 (the portion facing the connection bracket 74 when assembled). As a bolt hole or groove is formed in the fastened member 25, the resistance modules 10 and the control module 30 may be assembled into a single unit having a stacked structure by bolts that pass through the long holes 740 from the outside of the connection bracket 74 and are fastened to each fastened member 25.

In the partially separated perspective view of the brake resistor according to the embodiment of the present disclosure shown in FIG. 1, reference numeral 20 indicates an elastic pad. The elastic pad 20 may be interposed between the resistance module 10 and another neighboring resistance module 10 and between the resistance module 10 and the control module 30 for the purpose of reducing the occurrence of joints between modules and waterproofing. The elastic pad 20 is preferably, but not limited to, a silicone pad.

In addition, in FIGS. 1 to 3, reference numeral 19 indicates a housing cover coupled to cover a front opening of a terminal housing 16 of the resistance module 10, which will be described later.

The detailed configuration of the main components of the variable capacity stack-type brake resistor according to the embodiment of the present disclosure will be described.

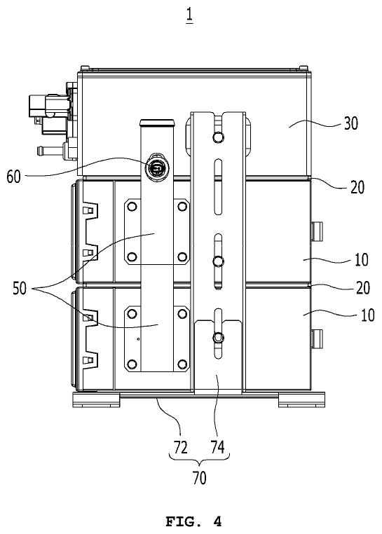

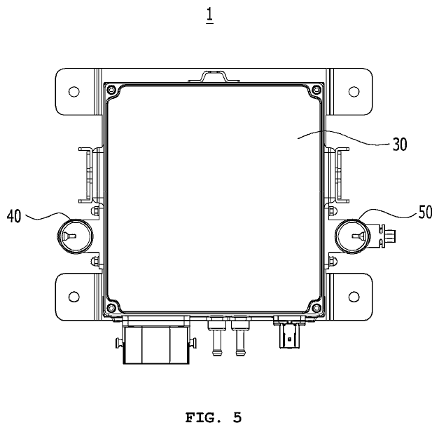

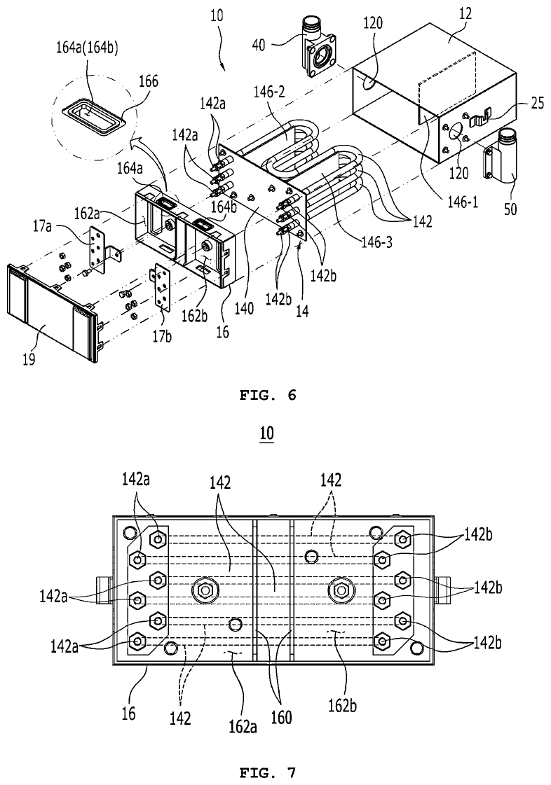

FIG. 6 is an exploded perspective view of a resistance module constituting the variable capacity stack-type brake resistor according to an embodiment of the present disclosure, FIG. 7 is a front view of a combined state of the resistance module in FIG. 6 with a housing cover and an integrated terminal omitted, and FIG. 8 is a front view of a combined state of the resistance module in FIG. 6 with only the housing cover omitted.

Referring to FIGS. 6 to 8, the resistance module 10 applied to the embodiment of the present disclosure includes: a coolant box 12 with one side (front side in the drawing) open; and a heating element assembly 14 coupled to the coolant box 12 through the open side of the coolant box 12 so that a portion thereof is located within the coolant box 12.

The coolant box 12 may be provided with the fluid inlet 120 and the fluid outlet 122 provided on one side and the other side thereof, respectively. The heating element assembly 14 may be composed of a sealing plate 140 and the heating element 142 coupled in an assembly form.

The fluid inlet 120 and the fluid outlet 122 may be respectively provided on one side and the other side of the coolant box 12. As the inlet port 40 and the outlet port 50 are respectively coupled to the fluid inlet 120 and the fluid outlet 122, a fluid may enter the coolant box 12 through the inlet port 40 and may be discharged to the outside through the outlet port 50. The above-described fastened members 25 may be attached one by one to all or some of the sides except for the open side of the coolant box 12.

The sealing plate 140 of the heating element assembly 14 may be sealingly coupled to the open side of the coolant box 12 through welding or the like. Electrode portions at both ends of the heating element 142 may be fixed to penetrate the sealing plate 140 and be exposed to the front portion of the sealing plate 140. A body portion (numeral omitted) of the heating element 142, which substantially generates heat when an electric current is supplied, is located within the coolant box 12, and the terminal housing 16 may be coupled to the front of the sealing plate 140.

A positive integrated terminal 17a and a negative integrated terminal 17b may be mounted in the terminal housing 16. A power electrode 142a on one end of the heating element 142, which penetrates the sealing plate 140 and protrudes to the front of the sealing plate 140 may be electrically connected to the positive integrated terminal 17a, while a ground electrode 142b on the other end of the heating element 142, which penetrates the sealing plate 140 and protrudes to the front of the sealing plate 140 may be electrically connected to the negative integrated terminal 17b.

Two or more heating elements 142 may be installed in one resistance module 10. Each of the heating elements 142 may have a corrugated shape with two or more bending points or inflection points in its planar shape, that is, a shape bent two or more times in a zigzag shape. The heating elements 142 may be spaced apart from each other in the height direction of the coolant box 12 at regular intervals. In the drawing, a configuration with six heating elements 142 per resistance module 10 is illustrated, but the configuration is not limited thereto.

In disposing the heating elements 142 to be spaced apart in the height direction of the coolant box 12, it is desirable to minimize the overlap, when viewed from a plan view, between the two neighboring heating elements 142 (see FIGS. 7 and 8) by differentiating (staggering from each other) the horizontal alignment positions of the two heating elements 142 that are adjacent to each other up and down. In this case, cooling efficiency may be improved by securing a sufficient flow rate by increasing a fluid passage area between two neighboring heating elements 142.

Respective power electrodes 142a of the two or more heating elements 142 (six heating elements in the drawing) included in one resistance module 10 may be electrically integrated by being connected to the single positive integrated terminal 17a described above. Respective ground electrodes 142b of the two or more heating elements 142 included in one resistance module 10 may be electrically integrated by being connected to the single negative integrated terminal 17b described above.

The internal space of the terminal housing 16 may be divided, by a central separation partition wall 160, into a first space 162a and a second space 162b in which the positive integrated terminal 17a and the negative integrated terminal 17b are respectively mounted. The upper and lower plates of the terminal housing 16 may be provided with bus bar through holes 164a and 164b through which bus bars 80a and 80b pass, wherein the bus bars 80a and 80b electrically connect the positive integrated terminal 17a and the negative integrated terminal 17b for the first space 162a and the second space 162b, respectively, to the control module 30.

A concave portion 166 may be formed around each of the bus bar through holes 164a and 164b. A protrusion portion 266 may be formed around bus bar through holes 264a and 264b of the elastic pad 20 corresponding to the bus bar through holes 164a and 164b (see FIG. 1). In this case, when assembling two or more resistance modules 10 in a stacked manner, the protrusion portion 266 of the elastic pad 20 interposed between the resistance modules 10 is engaged with the concave portion 166, preventing horizontal clearance and misassembly between the upper and lower neighboring resistance modules 10.

In FIG. 6, reference numeral 146 indicates a diaphragm installed to secure a path through which a fluid flows in a limited space within the coolant box 12, that is, the fluid flow path as long as possible. A plurality of diaphragms 146 may be installed alternately on the sealing plate 140 and inside the coolant box 12, and due to coupling of the sealing plate 140, the fluid flow path within the coolant box 12 may take a zigzag shape.

For example, when the heating element 142 is bent three times as shown in the example in the drawing, one diaphragm 146-1 is installed in the center of the coolant box 12, and when assembled, two diaphragms 146-2 and 146-3 may be installed on the sealing plate 140 so as to face each other with the coolant box 12 side diaphragm 146-1 interposed in between. Accordingly, due to the long fluid flow path, sufficient time may be secured for the fluid to take heat away from the heating element 142. As a result, the cooling efficiency of the heating element 142 may be greatly improved.

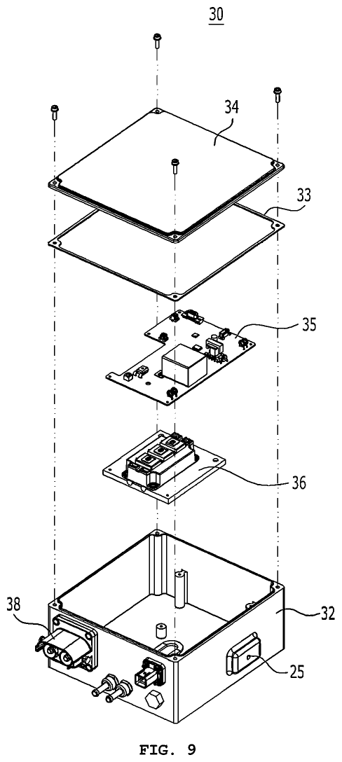

FIGS. 9 and 10 are views of a control module applied to the variable capacity stack-type brake resistor according to an embodiment of the present disclosure. FIG. 9 is an exploded perspective view of the control module, and FIG. 10 is a partially exploded perspective view of the control module.

Referring to FIGS. 9 and 10, the control module 30 includes a casing 32 with an open top and a cover 34 coupled to cover the upper open end of the casing 32. The substrate 35 equipped with a plurality of control elements for on/off and temperature control of the resistance module 10 is disposed inside the casing 32. At the bottom of the substrate 35, a heat sink 36 for cooling the highly heat generating control elements mounted on the substrate 35 may be disposed so that at least a portion of the heat sink 36 is in contact with the substrate 35.

In this case, the heat sink 36 may be a water-cooled or oil-cooled heat sink 36 in which cooling is implemented by heat exchange between a cooling fluid circulating along the interior of the heat sink and an object to be cooled (substrate 35), that is, the cooling fluid takes heat away from the object to be cooled while circulating inside the heat sink 36 to prevent overheating. It is obvious that the heat sink is not limited to the water-cooled or oil-cooled type mentioned above, and all known types of heat sinks 36 may also be applied.

In FIGS. 9 and 10, reference numeral 38 refers to a high-voltage connector to which a high-voltage cable for electrical connection between an external high-voltage power source, such as a high-voltage battery, and the control module 30 is connected. Reference numeral 33 indicates a cover seal interposed between the cover 34 and the casing 32 when the cover 34 is coupled.

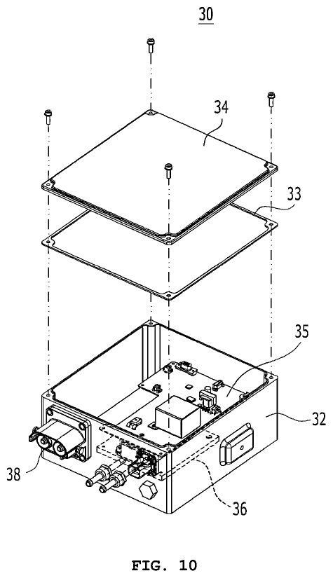

FIG. 11 is a view showing an electrical connection relationship between the resistance modules and the control module, and is a combined perspective view of the present disclosure with the housing cover omitted.

Referring to FIG. 11, each of the plurality of heating elements 142 included in one resistance module 10 has the power electrode 142a and the ground electrode 142b at one end and the other end, and among the electrodes provided on the heating elements 142, the power electrodes 142a may be electrically integrated by being connected to one positive integrated terminal 17a as previously mentioned, and the ground electrodes 142b may be electrically integrated by being connected to one negative integrated terminal 17b.

In the configuration in which two resistance modules 10 are assembled in a stacked manner, as shown in the example in the drawing, two positive integrated terminals 17a and two negative integrated terminals 17b may be configured (This is because each resistance module has one positive integrated terminal and one negative integrated terminal).

The positive integrated terminal 17a of each resistance module 10, for example, when there are two resistance modules 10 as shown in the example in the drawing, the two positive integrated terminals 17a may be simultaneously connected to a positive (+) terminal (numeral omitted) of the control module 30 through one first bus bar 80a. Likewise, the negative integrated terminal 17b of each resistance module 10, for example, when there are two resistance modules 10 as shown in the example in the drawing, the two negative integrated terminals 17b may be simultaneously connected to a negative (−) terminal (numeral omitted) of the control module 30 through one second bus bar 80b.

As such, when the positive integrated terminal 17a of each resistance module 10 is connected to the positive (+) terminal of the control module 30 by means of one first bus bar 80a and the negative integrated terminal 17b of each resistance module 10 is connected to the negative (−) terminal of the control module 30 by means of one second bus bar 80b, that is, when the plurality of resistance modules 10 are electrically connected in parallel to one control module 30, control (on/off control, temperature control, etc.) of the heating elements 142 of each resistance module 10 may be performed simultaneously.

In the embodiment, the first bus bar 80a connecting the positive integrated terminals 17a of the individual resistance modules 10 together and the second bus bar 80b connecting the negative integrated terminals 17b of the individual resistance modules 10 together may respectively pass through the above-described bus bar through holes 164a and 164b formed in each terminal housing 16 of the resistance module 10, and extend from the resistance module 10 toward the control module 30, or conversely, may extend from the control module 30 toward the resistance module 10.

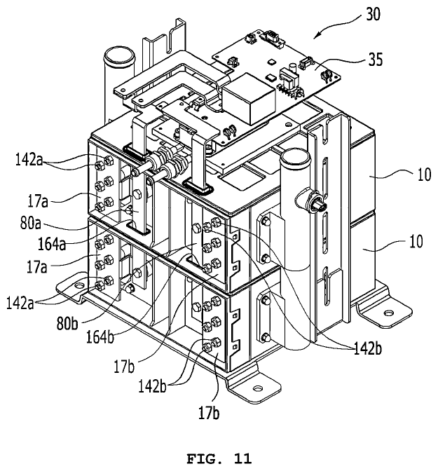

FIG. 12 is a front view of a variable capacity stack-type brake resistor according to another embodiment of the present disclosure showing another electrical connection relationship between resistance modules and a control module. The positive integrated terminal 17a of each resistance module 10, for example, when there are two resistance modules 10 as shown in the example in the drawing, the two positive integrated terminals 17a may be configured to be individually connected to the corresponding number of positive (+) terminals formed in the control module 30 by means of two corresponding unit bus bars 82a and 82b.

At this time, the negative integrated terminals 17b of the respective resistance modules 10 may be simultaneously connected to the negative (−) terminal of the control module 30 by means of one bus bar 80b.

In this way, when the positive integrated terminal 17a of each resistance module 10, for example, when there are two resistance modules 10 as shown in the example in the drawing, the two positive integrated terminals 17a are configured to be individually connected to the corresponding number of positive (+) terminals formed in the control module 30 by means of two corresponding unit bus bars 82a and 82b, individual control of each resistance module 10 is possible, allowing efficient energy consumption management according to the remaining surplus energy.

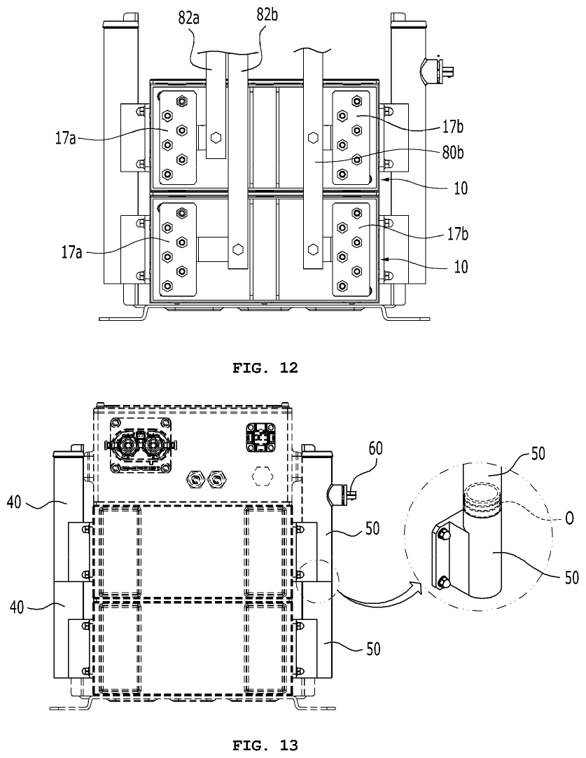

FIG. 13 is a view showing a preferred embodiment of an inlet port and an outlet port applied to the variable capacity stack-type brake resistor according to the embodiment of present disclosure. In this case, the inlet port 40 and the outlet port 50 are respectively configured on one side and the other side of the each resistance module 10, and the inlet ports 40 on one side of the resistance modules 10 may be connected to each other while the outlet ports 50 on the other side of the resistance modules 10 may be connected to each other.

At this time, at least one sealing member, such as an O-ring O, may be interposed in the connection portion between the two neighboring inlet ports 40 and the connection portion between the two neighboring outlet ports 50, as shown in the enlarged view of the main part in FIG. 13, to prevent fluid leakage through joint gaps that may occur due to assembly tolerances. In addition, the inlet port 40 or the outlet port 50 at the top or bottom may be closed at one end.

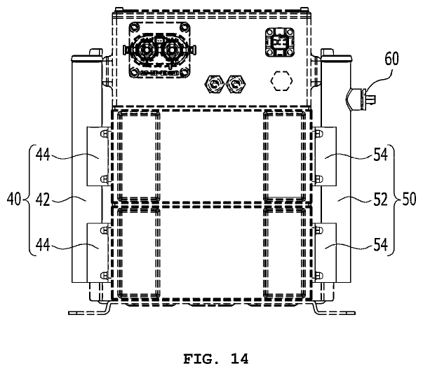

Alternatively, the inlet port 40 and the outlet port 50 may be configured as a single object as shown in FIG. 14, which shows another preferred embodiment of the inlet port and the outlet port. In this case, the inlet port 40 may be composed of two or more branch inlet pipes 44 branched from one main inlet pipe 42, and the outlet port 50 may be composed of two or more branch outlet pipes 54 branched from one main outlet pipe 52.

When the inlet port 40 and the outlet port 50 are each formed as a single object as in another preferred embodiment of FIG. 14, it is advantageous compared to the assembled structure of FIG. 13 in terms of leak management and assembly ability.

In FIGS. 13 and 14, reference numeral 60 indicates a water temperature sensor that detects the temperature of a fluid heated up while passing through the inside of the resistance module 10. The water temperature sensor 60 may be attached to the final outlet end (outlet side) of the outlet port 50 and may be electrically connected to the control module 30. In this case, the control module 30 feedback controls the resistance module 10 on the basis of the detection information of the water temperature sensor 60, so that the consumption of surplus energy may be adjusted.

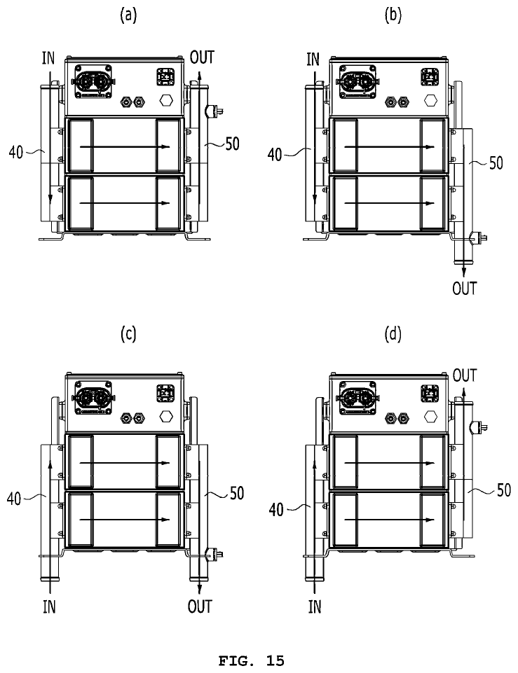

FIG. 15 is a view showing various modifications of the positions of an inlet of the inlet port 40 (the part where a fluid flows in) and an outlet of the outlet port 50 (the part where a fluid with an increased temperature is discharged. The inlet of the inlet port 40 through which a fluid flows in and the outlet of the outlet port 50 through which the fluid passing through the inside of the resistance module 10 is discharged may be changed in various ways as shown in (a) to (d) of FIG. 15 depending on the location of a pump or interference with other parts around a mounting portion when mounted on an actual vehicle.

The brake resistor according to the embodiments of the present disclosure described above is a stacked assembly type, and thus the number of resistance modules to be stacked may be easily adjusted as needed. That is, the entire capacity of the brake resistor may be easily varied to meet the required specifications, and requests for specification changes may be quickly responded to without major equipment changes or replacement.

Furthermore, as the brake resistor is structured in a box shape as a whole, the brake resistor does not take up an unnecessary amount of space, making it advantageous for installation in an actual vehicle and improving space utilization. In addition, the on/off or temperature of the resistance modules may be controlled simultaneously or individually, allowing efficient energy consumption management according to the remaining energy. In the event of a failure, only a failed part (module) needs to be replaced, which may save maintenance costs.

In the above detailed description of the present disclosure, only special embodiments thereof have been described. However, it should be understood that the present disclosure is not limited to the particular forms mentioned in the detailed description, but rather should be understood to include all modifications, equivalents and substitutes within the spirit and scope of the present disclosure as defined by the appended claims.

1-15. (canceled)

16. A variable capacity stack-type brake resistor, comprising:
at least one resistance module having one or more heating elements therein;
one control module including a substrate electrically connected to the heating elements;
an inlet port connected to a fluid inlet on a first side of the resistance module; and
an outlet port connected to a fluid outlet on a second side of the resistance module,
wherein the resistance module is provided in a box shape with flat upper and lower surfaces, and the control module is assembled in a stacked manner on the upper surface of the resistance module.

17. The brake resistor of claim 16, wherein two or more resistance modules are provided and the two or more resistance modules are assembled in a stacked manner, and the control module is assembled in the stacked manner on the upper surface of the resistance module located at a top among the resistance modules assembled in the stacked manner.

18. The brake resistor of claim 17, wherein the resistance modules and the control module are stacked and combined into one unit by means of a connection unit.

19. The brake resistor of claim 18, wherein the connection unit comprises:
a base plate mounted in contact with the lower surface of the resistance module located at a bottom among the resistance modules; and
at least one connection bracket that extends vertically from the base plate and secures the resistance modules and the control module.

20. The brake resistor of claim 17, wherein each of the one or more heating elements of each of the resistance modules has a power electrode and a ground electrode at a first end and a second end, respectively, thereof,
wherein the power electrodes of the heating elements are simultaneously connected to a positive (+) terminal of the control module by means of a first bus bar, and the ground electrodes of the heating elements are simultaneously connected to a negative terminal of the control module by means of a second bus bar, so that temperatures of the heating elements are controlled simultaneously.

21. brake resistor of claim 17, wherein each of the one or more heating elements of each of the resistance modules has a power electrode and a ground electrode at a first end and a second end, respectively, thereof,
wherein the power electrodes of the heating elements are individually connected to a corresponding number of positive (+) terminals provided in the control module by means of unit bus bars, and the ground electrodes of the heating elements are simultaneously connected to a negative (−) terminal of the control module by means of one bus bar, so that temperatures of the heating elements are controlled individually.

22. The brake resistor of claim 17, wherein an inlet port on a first side of any one of the resistance modules is connected to an inlet port on a first side of another resistance module adjacent to the any one of the resistance modules, and an outlet port on a second side of any one of the resistance modules is connected to an outlet port on a second side of another resistance module adjacent to the any one of the resistance modules.

23. The brake resistor of claim 17, wherein the inlet port is configured as a single object in which two or more branch inlet pipes are branched from one main inlet pipe, and the outlet port is configured as a single object in which two or more branch outlet pipes are branched from one main outlet pipe.

24. The brake resistor of claim 17, wherein an elastic pad is interposed between any one of the resistance modules and another resistance module adjacent to the any one of the resistance modules, and between the resistance module and the control module.

25. The brake resistor of claim 16, wherein a water temperature sensor is attached to the outlet port to detect temperature of a fluid that has been heated up while passing through the resistance module.

26. The brake resistor of claim 16, wherein the resistance module comprises:
a coolant box with a side open and the fluid inlet and the fluid outlet formed;
a sealing plate sealingly coupled to the open side of the coolant box, and a heating element assembly consisting of the heating elements, which is placed inside the coolant box and opposite ends of which are fixed to the sealing plate; and
a terminal housing coupled to a front of the sealing plate, and that mounts a positive integrated terminal and a negative integrated terminal respectively connected to a power electrode at a first end of each of the heating elements and a ground electrode at a second end of each of the heating elements.

27. The brake resistor of claim 26, wherein each of the resistance modules consists of two or more heating elements, each heating element has a corrugated shape with two or more bending points or inflection points in a planar shape thereof, the heating elements are spaced apart from each other at a predetermined distance in a height direction of the coolant box, and two heating elements adjacent to each other above and below have different horizontal alignment positions.

28. The brake resistor of claim 26, wherein an internal space of the terminal housing is divided, by a central separation partition wall, into a first space and a second space in which the positive integrated terminal and the negative integrated terminal are respectively mounted, and
upper and lower plates of the terminal housing are provided with bus bar through holes through which bus bars pass, wherein the bus bars electrically connect the positive integrated terminal and the negative integrated terminal for the first space and the second space, respectively, to the control module.

29. The brake resistor of claim 26, wherein a diaphragm is installed on the sealing plate and inside the coolant box to divide a fluid flow path in the coolant box in a zigzag shape when the sealing plate is combined with the coolant box.

30. The brake resistor of claim 16, wherein the control module is provided with a casing with an open top and a cover coupled to cover an upper open end of the casing,
wherein the substrate is placed inside the casing, and a heat sink for cooling highly heat generating control elements mounted on the substrate is disposed inside the casing so that at least a portion of the heat sink is in contact with the substrate.
